(19) United States
(12) Patent Application Publication
(10) Pub. No.: US 2020/0167013 A1
(43) Pub. Date: May 28, 2020

(54) DISPLAY SYSTEM

(71) Applicant: Yoshito SAITO, Kanagawa (JP)

(72) Inventor: Yoshito SAITO, Kanagawa (JP)

(73) Assignee: Ricoh Company, Ltd., Tokyo (JP)

(21) Appl. No.: 16/688,298

(22) Filed: Nov. 19, 2019

(30) Foreign Application Priority Data
Nov. 27, 2018 (JP) 2018-221641

(51) Int. Cl. G06F 3/0354; G06F 3/044; G06F 1/16

(52) U.S. Cl. CPC G06F 3/03545; G06F 1/1607; G06F 3/0441

(57) ABSTRACT

A display system includes a pen; a display input device configured to accept input by the pen; and an extension function device to be coupled to a housing of the display input device. The extension function device includes an extension function for extending a function of the display input device. The display input device includes a first attachment portion to which the extension function device is attachable, on a first side of the housing; and a second attachment portion to which the extension function device is attachable, on a second side of the housing adjacent to the first side. The pen is detachably attached to the second attachment portion when the extension function device is attached to the first attachment portion, and the pen is detachably attached to the first attachment portion when the extension function device is attached to the second attachment portion.

### CROSS-REFERENCE TO RELATED APPLICATION

The present application is based on and claims priority under 35 U.S.C. § 119 to Japanese Patent Application No. 2018-221641, filed on Nov. 27, 2018, the contents of which are incorporated herein by reference in their entirety.

### BACKGROUND OF THE INVENTION

### 1. Field of the Invention

The present invention relates to a display system.

### 2. Description of the Related Art

Patent Document 1 discloses a digital still camera provided with a pen housing portion, in which a pen-like input device is removably housed, in a camera case provided with a display panel. Further, Patent Document 2 discloses a speaker device that can be attached to the lower portion of a liquid crystal display having a horizontally long rectangular shape.
Patent Document 1: Japanese Unexamined Patent Application Publication No. 2008-098763
Patent Document 2: Japanese Unexamined Patent Application Publication No. 2009-284157

### SUMMARY OF THE INVENTION

According to one aspect of the present invention, there is provided a display system including a pen; a display input device configured to accept input by the pen; and an extension function device configured to be coupled to a housing of the display input device, and including an extension function for extending a function of the display input device, wherein the display input device includes a first attachment portion to which the extension function device is attachable, on a first side of the housing; and a second attachment portion to which the extension function device is attachable, on a second side of the housing adjacent to the first side, and wherein the pen is configured to be detachably attached to the second attachment portion in a state where the extension function device is attached to the first attachment portion, and the pen is configured to be detachably attached to the first attachment portion in a state where the extension function device is attached to the second attachment portion.

### BRIEF DESCRIPTION OF THE DRAWINGS

FIGS. 1A and 1B are diagrams illustrating the appearance of an Interactive White Board (IWB) according to an embodiment of the present invention;

FIGS. 2A and 2B are diagrams illustrating a usage mode of the IWB according to an embodiment of the present invention; and

FIGS. 3A and 3B are diagrams illustrating a pen holding structure in the IWB according to an embodiment of the present invention.

### DETAILED DESCRIPTION OF THE PREFERRED EMBODIMENTS

There are display systems including a display input device, to which information can be input by using a pen. This display input device can be used in each of a first orientation that is a horizontally long rectangular shape and a second orientation that is a vertically long rectangular shape. In such a display system, by combining the technology of Patent Document 1 and the technology of Patent Document 2, it is possible to apply a configuration in which a speaker can be attached to the lower portion of the display input device and a pen can be held on the side portion of the display input device, in both the first orientation and the second orientation. When such a configuration is applied, it is necessary to provide the display input device with a holding structure for holding the speaker at the lower portion of the display input device and a holding structure for holding the pen at the side portion of the display input device in the first orientation, and a holding structure for holding the speaker at the lower portion of the display input device and a holding structure for holding the pen at the side portion of the display input device in the second orientation.

A problem to be addressed by an embodiment of the present invention is to suppress an increase in the number of holding structures for a display input device.

### EMBODIMENT

Hereinafter, an embodiment of the present invention will be described with reference to the drawings.

### (Outline of IWB 100)

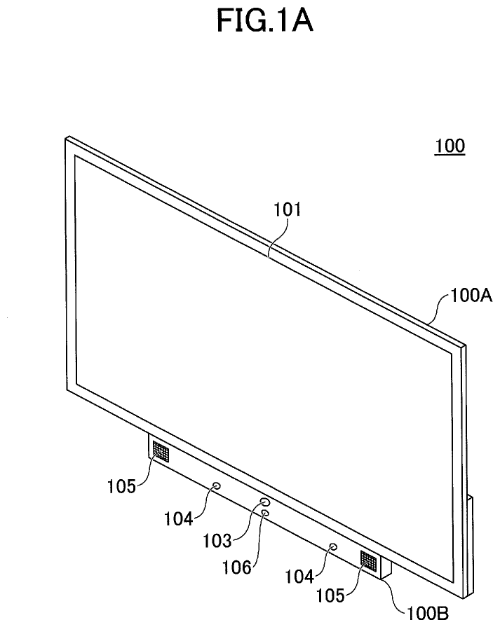

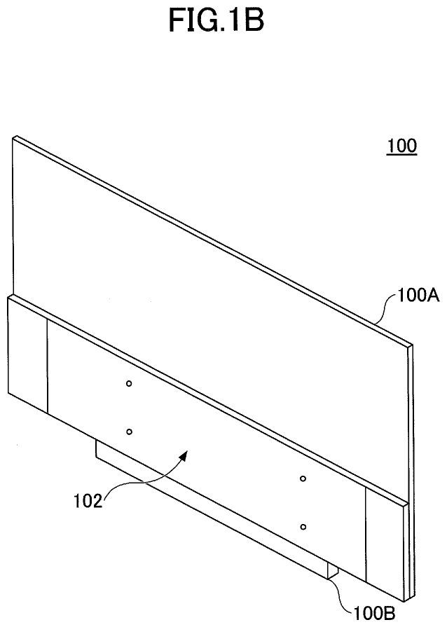

FIGS. 1A and 1B illustrate the external appearance of an Interactive White Board (IWB) 100 according to an embodiment of the present invention. FIG. 1A illustrates the front side of the IWB 100, and FIG. 1B illustrates the back side of the IWB 100. The IWB 100 is an example of a “display system”.

The IWB 100 illustrated in FIGS. 1A and 1B can be used as a video conference communication terminal that is installed at each location where video conferencing takes place and used by participants of the video conference. For example, the IWB 100 may be included in a video conferencing system together with other IWBs 100 via a network such as the Internet, an intranet, a local area network (LAN), or the like.

The IWB 100 can transmit various kinds of data (for example, video data, voice sound data, drawing data, etc.) input from a participant at an own location of the video conference, to the IWB 100 at another location, via a network. Further, the IWB 100 can present various kinds of data input from a participant of an own location or various kinds of data transmitted from the IWB 100 of another location, to participants of the video conference, by outputting the data by an output method (for example, display, voice sound output, etc.) according to the type of the data.

As illustrated in FIGS. 1A and 1B, the IWB 100 includes a main body 100A and a media box 100B. The main body 100A is an example of a “display input device”. The main body 100A has a rectangular shaped housing. The media box 100B is an example of an “extension function device”. The media box 100B has a rectangular shaped housing and is detachably attached to the main body 100A. When the media box 100B is connected to the main body 100A, power is supplied from the main body 100A, so that the media box 100B can be used.

The main body 100A has a touch panel display 101 on the front side thereof and a controller box 102 on the back side thereof. The media box 100B includes a camera 103, a microphone 104, a speaker 105, and a power button 106, which are provided on the front side thereof.

The touch panel display 101 is a device provided with a display and touch panel. The touch panel display 101 can display various kinds of information (for example, video data, drawing data, etc.) by the display. Further, the touch panel display 101 can input various kinds of information (for example, characters, figures, images, etc.) by a contact operation of an operator body (for example, a finger, a pen 150, etc.) by the touch panel. As the display, for example, a liquid crystal display, an organic electro-luminescence (EL) display, electronic paper, or the like may be used. As the touch panel, for example, a capacitance type touch panel may be used.

The controller box 102 performs various control operations for the IWB 100. For example, the controller box 102 controls various pieces of hardware included in the IWB 100, and controls the execution of various functions related to the video conference included in the IWB 100. Further, the controller box 102 can control the pieces of hardware provided in the media box 100B, by having the media box 100B connected.

The camera 103 captures an image in front of the IWB 100. The camera 103 is configured with, for example, a lens, an image sensor, and an image processing circuit such as a digital signal processor (DSP). The image sensor generates image data (RAW data) by photoelectric conversion of light collected by the lens. Examples of the image sensor include a Charge Coupled Device (CCD) and a Complementary Metal Oxide Semiconductor (CMOS). The image processing circuit performs general image processing such as bayer conversion, 3A control (automatic exposure control (AE), auto focus (AF), and auto white balance (AWB)) on image data (RAW data) generated by the image sensor, in order to generate image data (YUV data). The image processing circuit outputs the generated image data (YUV data). The YUV data expresses color information by a combination of a luminance signal (Y), the difference between the luminance signal and a blue component (U), and the difference between the luminance signal and a red component (V).

The microphone 104 collects the voice sound in front of the IWB 100 and generates voice sound data (analog data) corresponding to the collected voice sound, and then performs analog-to-digital conversion on the generated voice sound data (analog data) to output voice sound data (digital data) corresponding to the collected voice sound.

The speaker 105 outputs voice sound corresponding to the voice sound data by being driven by the voice sound data (analog data). For example, the speaker 105 outputs voice sound collected at the IWB 100 at another location by being driven by voice sound data transmitted from the IWB 100 at the other location.

The power button 106 is a button that is pressed/operated by a user to switch between power on and off of the IWB 100.

The IWB 100 configured as described above can share the image data acquired by the camera 103, the drawing data acquired by the touch panel display 101, and the voice sound data acquired by the microphone 104, with the IWB 100 of another location, by sending this data to the IWB 100 of another location via the network. The IWB 100 may also display, on the touch panel display 101, the display contents based on image data and drawing data transmitted from the IWB 100 of another location, and output, by the speaker 105, voice sound based on voice sound data transmitted from the IWB 100 of another location, so as to share this information with another IWB 100.

### (Usage Mode of IWB 100)

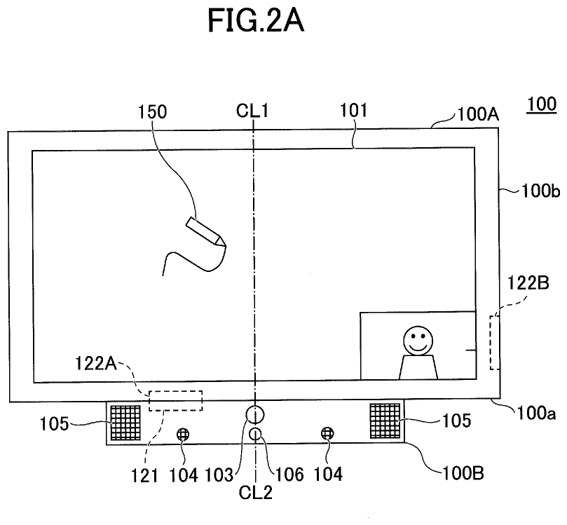

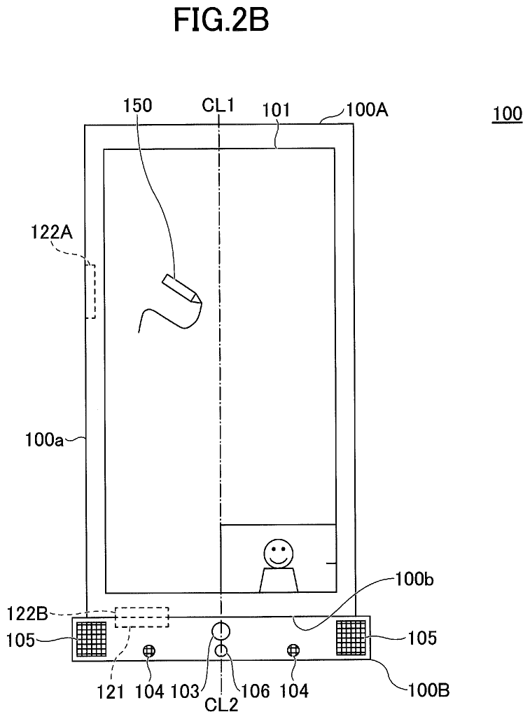

FIGS. 2A and 2B illustrate a usage mode of the IWB 100 according to an embodiment of the present invention. FIG. 2A illustrates the IWB 100 in a state in which the main body 100A is oriented to have a horizontally long rectangular shape (hereinafter, referred to as “a first orientation”), and FIG. 2B illustrates the IWB 100 in a state in which the main body 100A is rotated 90 degrees to be oriented to have a vertically long rectangular shape (hereinafter, referred to as “a second orientation”).

As illustrated in FIGS. 2A and 2B, the IWB 100 is configured such that the media box 100B, which is oriented to have a horizontally long rectangular shape, can be connected to the lower side of the main body 100A, with a centerline CL1 of the main body 100A and a centerline CL2 of the media box 100B matching each other, both in a state where the main body 100A is in the first orientation and in a state where the main body 100A is in the second orientation.

Specifically, the media box 100B is provided with a connector 121 at the upper side portion that is the long side portion on the side to which the main body 100A is connected. On the other hand, as illustrated in FIG. 2A, the main body 100A is provided with a connector 122A, which can be connected to the connector 121, on a first side 100a that is the long side portion on the side to which the media box 100B is connected when the main body 100A is in the first orientation. Further, as illustrated in FIG. 2B, the main body 100A is provided with a connector 122B, which can be connected with the connector 121, on a second side 100b that is the short side portion on the side to which the media box 100B is connected when the main body 100A is in the second orientation.

Thus, as illustrated in FIG. 2A, when the main body 100A is in the first orientation, the connector 122A of the main body 100A faces the connector 121 of the media box 100B so that the connector 122A and the connector 121 can be connected to each other. In this case, the amount of offset and the direction of offset from the centerline CL1 of the connector 122A are the same as the amount of offset and the direction of offset from the centerline CL2 of the connector 121, and, therefore, it is possible to connect the connector 122A and the connector 121 by facing each other while the centerline CL1 and the centerline CL2 are matched.

Further, as illustrated in FIG. 2B, when the main body 100A is in the second orientation, the connector 122B of the main body 100A faces the connector 121 of the media box 100B, so that the connector 122B and the connector 121 can be connected to each other. In this case, the amount of offset and the direction of offset from the centerline CL1 of the connector 122B are the same as the amount of offset and the direction of offset from the centerline CL2 of the connector 121, and, therefore, the connector 122B and the connector 121 can be connected to each other by facing each other while the centerline CL1 and the centerline CL2 are matched.

Note that when the media box 100B is connected to the connector 122A as illustrated in FIG. 2A, the main body 100A can switch the display of the touch panel display 101 such that the horizontal direction and the vertical direction of the display screen correspond to the first orientation. Further, when the media box 100B is connected to the connector 122B as illustrated in FIG. 2B, the main body 100A can switch the display of the touch panel display 101 such that the horizontal direction and the vertical direction of the display screen correspond to the second orientation.

### (Holding Structure of Pen 150)

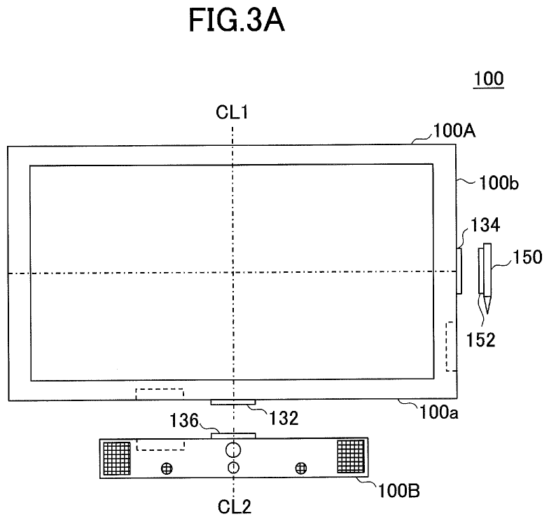

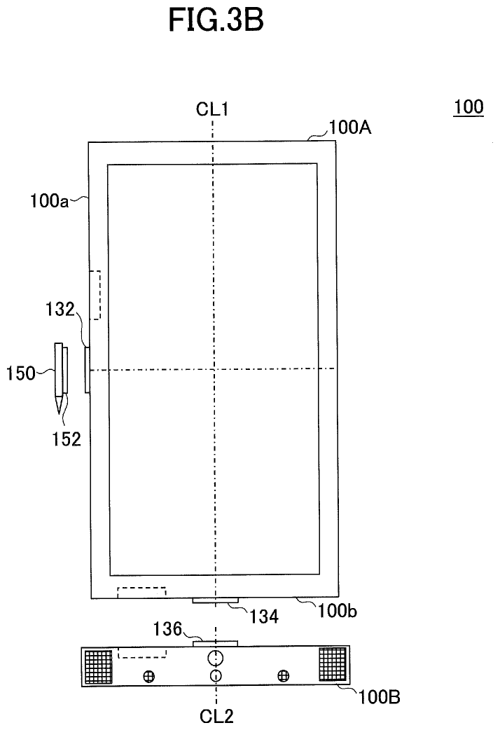

FIGS. 3A and 3B illustrate the holding structure of the pen 150 of the IWB 100 according to an embodiment of the present invention. FIG. 3A illustrates the IWB 100 in a state where the main body 100A is in the first orientation to have a horizontally long rectangular shape, and FIG. 3B illustrates the IWB 100 in a state where the main body 100A is rotated 90 degrees to be in the second orientation to have a vertically long rectangular shape.

As illustrated in FIGS. 3A and 3B, the main body 100A is provided with a magnetic body 132 shaped as a flat plate (an example of a “first attachment portion”) at the center of the first side 100a that is the long side on the side to which the media box 100B is connected when the main body 100A is in the first orientation. Further, the main body 100A is provided with a magnetic body 134 shaped as a flat plate (an example of a “second attachment portion”) at the center of the second side 100b that is the short side on the side to which the media box 100B is connected when the main body 100A is in the second orientation. On the other hand, the media box 100B is provided with a magnet 136 shaped as a flat plate at the center of the upper side portion that is a long side portion on the side to which the main body 100A is connected.

Thus, as illustrated in FIG. 3A, when the main body 100A is in the first orientation, the magnetic body 132 provided at the center of the first side 100a of the main body 100A faces the magnet 136 provided at the center of the upper side portion of the media box 100B. Accordingly, in the IWB 100 according to the present embodiment, when the main body 100A is in the first orientation, the magnetic body 132 provided on the main body 100A can be magnetically attached to the magnet 136 provided on the media box 100B so that the main body 100A and the media box 100B can be fixed to each other, with the centerline CL1 of the main body 100A and the centerline CL2 of the media box 100B matched to each other.

Further, as illustrated in FIG. 3A, when the main body 100A is in the first orientation, the magnetic body 134 provided at the center of the second side 100b of the main body 100A is positioned on the side portion of the main body 100A. Accordingly, in the IWB 100 according to the present embodiment, when the main body 100A is in the first orientation, on the side portion of the main body 100A, the pen 150 can be detachably attached by causing a magnet 152 provided in the pen 150 to be magnetically attached to the magnetic body 134.

As illustrated in FIG. 3B, when the main body 100A is in the second orientation, the magnetic body 134 provided at the center of the second side 100b of the main body 100A faces the magnet 136 provided at the center of the upper side portion of the media box 100B. Accordingly, in the IWB 100 according to the present embodiment, when the main body 100A is in the second orientation, the magnetic body 134 provided on the main body 100A can be magnetically attached to the magnet 136 provided on the media box 100B so that the main body 100A and the media box 100B can be fixed to each other with the centerline CL1 of the main body 100A and the centerline CL2 of the media box 100B matched to each other.

As illustrated in FIG. 3B, when the main body 100A is in the second orientation, the magnetic body 132 provided at the center of the first side 100a of the main body 100A is positioned on the side portion of the main body 100A. Accordingly, in the IWB 100 according to the present embodiment, when the main body 100A is in the second orientation, on the side portion of the main body 100A, the pen 150 can be detachably attached, by causing the magnet 152 provided in the pen 150 to be magnetically attached to the magnetic body 132.

As described above, the IWB 100 according to the present embodiment includes the pen 150, the main body 100A that can accept input from the pen 150, and the media box 100B that can be connected to the housing of the main body 100A and that has an extension function to extend the function of the main body 100A; the main body 100A has the magnetic body 132 to which the media box 100B can be attached, on the first side 100a of the housing, and the magnetic body 134 to which the media box 100B can be attached, on the second side 100b adjacent to the first side 100a of the housing; and the pen 150 can be detachably attached to the magnetic body 134 in a state where the media box 100B is attached to the magnetic body 132 and the pen 150 can be detachably attached to the magnetic body 132 in a state where the media box 100B is attached to the magnetic body 134.

Thus, in the IWB 100 according to the present embodiment, when the media box 100B is attached to one of the magnetic bodies 132 and 134, the pen 150 can be held by the other one of the magnetic bodies 132 and 134. That is, the IWB 100 according to the present embodiment does not need to be provided with a holding structure that is exclusively used for holding the pen 150. Thus, according to the IWB 100 according to the present embodiment, it is possible to suppress an increase in the number of the holding structures in the main body 100A.

In particular, in the IWB 100 according to the present embodiment, the main body 100A can be used in the first orientation in which the housing is horizontally long and the second orientation in which the housing is vertically long. In the first orientation, the media box 100B is attached to the magnetic body 132 and the pen 150 is detachably attached to the magnetic body 134. In the second orientation, the media box 100B is attached to the magnetic body 134 and the pen 150 is detachably attached to the magnetic body 132.

Accordingly, in the IWB 100 according to the present embodiment, the media box 100B can be attached by one of the magnetic bodies 132 and 134 located at the lower portion of the main body 100A, and the pen 150 can be held by the other one of the magnetic bodies 132 and 134 located on a side portion of the main body 100A, in both the first orientation and the second orientation.

Further, in the IWB 100 according to the present embodiment, magnetic bodies are used as the magnetic bodies 132 and 134, and the media box 100B and the pen 150 can be attached by the magnetic force generated in the magnetic bodies.

Accordingly, the IWB 100 according to the present embodiment can implement a holding structure for the media box 100B and the pen 150, by a relatively simple structure, by using a metal plate as the magnetic bodies 132 and 134, for example.

While the preferred embodiments of the invention have been described in detail above, the present invention is not limited to these embodiments, and various modifications or variations are possible within the scope of the invention as defined in the appended claims.

For example, in the embodiment described above, the pen 150 is detachably attached to the main body 100A by providing the magnet 152 to the pen 150; however, an embodiment of the present invention is not limited as such. For example, the pen 150 may be detachably attached to the main body 100A by providing the magnet 152 to a pen holder holding the pen 150. That is, the concept of “the pen being detachably attached” also includes “a pen held in a pen holder being detachably attached”.

For example, in the above-described embodiment, the pen 150 and the media box 100B can be detachably attached to the main body 100A by using a magnetic force; however, an embodiment of the present invention is not limited as such. For example, an engagement structure may be used to detachably attach the pen 150 and the media box 100B to the main body 100A.

For example, the above-described embodiment uses the IWB 100 (electronic white board) as an example of the “display system”; however, an embodiment of the present invention is not limited as such. The present invention is applicable to various display systems (for example, smartphones, tablet terminals, etc.), as long as the display system is provided with a display input device that is capable of accepting input from a pen.

For example, in the above-described embodiment, the media box 100B can be connected to the lower portion of the main body 100A, when the main body 100A is used in the first orientation and in the second orientation; however, an embodiment of the present invention is not limited as such. For example, the media box 100B may be connected to an upper portion or a side portion of the main body 100A, when the main body 100A is used in the first orientation and in the second orientation.

For example, the above-described embodiment uses the media box 100B including the camera 103, the microphone 104, and the speaker 105 as an example of an “extension function device”; however, an embodiment of the present invention is not limited as such. The “extension function device” may be any device capable of extending the function of the main body 100A.

According to one embodiment of the present invention, an increase in the number of holding structures for a display input device is suppressed.

The display system is not limited to the specific embodiments described in the detailed description, and variations and modifications may be made without departing from the spirit and scope of the present invention.

What is claimed is:

1. A display system comprising:
a pen;
a display input device configured to accept input by the pen; and
an extension function device configured to be coupled to a housing of the display input device, and including an extension function for extending a function of the display input device, wherein
the display input device includes:
a first attachment portion to which the extension function device is attachable, on a first side of the housing; and
a second attachment portion to which the extension function device is attachable, on a second side of the housing adjacent to the first side, and wherein
the pen is configured to be detachably attached to the second attachment portion in a state where the extension function device is attached to the first attachment portion, and
the pen is configured to be detachably attached to the first attachment portion in a state where the extension function device is attached to the second attachment portion.

2. The display system according to claim 1, wherein
the display input device is configured to be used in a first orientation in which the housing is horizontally long and a second orientation in which the housing is vertically long,
when the display input device is in the first orientation, the extension function device is attached to the first attachment portion and the pen is detachably attached to the second attachment portion, and
when the display input device is in the second orientation, the extension function device is attached to the second attachment portion and the pen is detachably attached to the first attachment portion.

3. The display system according to claim 1, wherein
a magnetic body is used as the first attachment portion and the second attachment portion, and
the extension function device and the pen are configured to be attached by a magnetic force generated by the magnetic body.
